(19) United States
(12) Patent Application Publication
(10) Pub. No.: US 2024/0280373 A1
(43) Pub. Date: Aug. 22, 2024

(54) TRAVEL-BASED GEO-PAIRED INFORMATION SYSTEM WITH AI INTEGRATION

(71) Applicant: Charles Isgar, Scottsdale, AZ (US)

(72) Inventor: Charles Isgar, Scottsdale, AZ (US)

(21) Appl. No.: 18/653,816

(22) Filed: May 2, 2024

Related U.S. Application Data
(63) Continuation-in-part of application No. 17/697,307, filed on Mar. 17, 2022.
Application No. 17/697,307 is a continuation-in-part of application No. 17/555,672, filed on Dec. 20, 2021, now Pat. No. 11,725,961.
Application No. 17/555,672 is a continuation of application No. 16/706,698, filed on Dec. 7, 2019, now Pat. No. 11,204,255.
(60) Provisional application No. 62/776,514, filed on Dec. 7, 2018.

(51) Int. Cl. G01C 21/36; G01C 21/34; G06F 16/29; G06F 16/487; H04W 4/021; H04W 4/18

(52) U.S. Cl. CPC G01C 21/3682; G01C 21/3476; G01C 21/3644; G06F 16/29; G06F 16/487; H04W 4/021; H04W 4/185

(57) ABSTRACT

Described is a travel-based geo-paired information system with AI integration. The system includes a server having a memory storing geo-paired information that includes content regarding or related to a point of interest. The system also includes a user computing device coupled to the server. The server may be programmed to receive location information from the user computing device. The server may also be programmed to automatically process the location information and determine whether a location of the user computing device is within a predetermined distance from a point of interest geolocation. Then the server may retrieve geo-paired information corresponding to or paired to the point of interest geolocation and deliver to the user computing device, for presenting, the content related to the point of interest corresponding to the location of the user computing device. The server may use AI software to generate the content stored in the server.

### CROSS REFERENCE TO RELATED APPLICATION[S]

This application is a continuation-in-part of U.S. patent application Ser. No. 17/697,307, filed Mar. 17, 2022, which is a continuation-in-part of U.S. patent application Ser. No. 17/555,672, filed Dec. 20, 2021, which is a continuation of U.S. patent application Ser. No. 16/706,698, filed Dec. 7, 2019, now U.S. Pat. No. 11,204,255, which claims priority to U.S. Provisional Patent Application Ser. No. 62/776,514, filed Dec. 7, 2018, the disclosure of which is hereby incorporated entirely herein by reference.

### BACKGROUND OF THE INVENTION

### Technical Field

This invention generally relates to information systems providing content to travelers in vehicles, and specifically to a travel-based geo-paired information system that integrates artificial intelligence software for providing content related to points of interest to travelers based on the real time geolocation of the traveler.

### State of the Art

Individuals who travel an extended distance often do so in cars, trains, planes or the like. Generally, long-distance travel includes travel through various parts of a state, region, or country. Many travelers utilize music, audio books, movies, or other forms of entertainment during a long trip over an extended distance. These forms of entertainment are typically stored or otherwise provided on a mobile computing device, a radio, a vehicle audio/video system and the like. However, this entertainment does not correlate to the route travelled. The route travelled by a traveler often includes passage by a historical site, a particular region and monument or other geographical, historical, important and/or interesting location. These locations typically have a story or information that is interesting. There is a lack of systems or devices that can allow a traveler to obtain information about these historical sites, particular regions and monuments or other geographical, historical, important and/or interesting locations.

Accordingly, what is needed is an audio and/or video entertainment system with artificial intelligence integration for travelers based on the real-time geolocation of the traveler.

### SUMMARY OF THE INVENTION

An embodiment includes a travel-based geo-paired information system with AI integration, the system comprising: a server having a memory storing geo-paired information; and a user computing device coupled to the server, wherein the server is programmed with AI software to: receive location information from the user computing device; automatically process the location information and determine whether a location of the user computing device is within a predetermined distance from a point of interest geolocation; automatically find and retrieve geo-paired information corresponding to the point of interest geolocation; automatically deliver to the user computing device for presenting content corresponding with the geo-paired information corresponding to the location of the user computing device; and execute a learning model to determine user preferences based on predictions formed through execution of the learning model on past interactions with the system through the user computing device.

Another embodiment includes a travel-based geo-paired information system with AI integration, the system comprising: a server having a memory storing geo-paired information; and a user computing device coupled to the server, wherein the server is programmed with AI software to: receive location information from the user computing device; automatically process the location information and determine whether a location of the user computing device is within a predetermined distance from a point of interest geolocation; automatically find and retrieve geo-paired information corresponding to the point of interest geolocation; automatically deliver to the user computing device for presenting content corresponding with the geo-paired information corresponding to the location of the user computing device; and link one or more social media platforms with the system, the one or more social media platforms corresponding to social media accounts of the user.

The foregoing and other features and advantages of the invention will be apparent to those of ordinary skill in the art from the following more particular description of the invention and the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1A is a diagrammatic view of a travel-based geo-paired information system according to an embodiment;

FIG. 1B is a diagrammatic view of a travel-based geo-paired information system according to an embodiment;

FIG. 2 depicts a user computing device of a travel-based geo-paired information system according to an embodiment;

FIG. 3A depicts a user computing device of a travel-based geo-paired information system according to an embodiment;

FIG. 3B depicts a user computing device of a travel-based geo-paired information system according to an embodiment;

FIG. 4A depicts a user computing device of a travel-based geo-paired information system according to an embodiment;

FIG. 4B depicts a user computing device of a travel-based geo-paired information system according to an embodiment;

FIG. 4C depicts a user computing device of a travel-based geo-paired information system according to an embodiment;

FIG. 4D depicts a user computing device of a travel-based geo-paired information system according to an embodiment;

FIG. 4E depicts a user computing device of a travel-based geo-paired information system according to an embodiment;

FIG. 4F depicts a user computing device of a travel-based geo-paired information system according to an embodiment;

FIG. 4G depicts a user computing device of a travel-based geo-paired information system according to an embodiment;

FIG. 4H depicts a user computing device of a travel-based geo-paired information system according to an embodiment;

FIG. 5A depicts a user computing device of a travel-based geo-paired information system used with social media applications according to an embodiment;

FIG. 5B depicts a user computing device of a travel-based geo-paired information system used with social media applications according to an embodiment;

FIG. 5C depicts a user computing device of a travel-based geo-paired information system used with social media applications according to an embodiment;

FIG. 5D depicts a user computing device of a travel-based geo-paired information system used with social media applications to start an AI initiated group chat according to an embodiment;

FIG. 5E depicts a user computing device of a travel-based geo-paired information system used with social media applications to start an AI recommended listens according to an embodiment;

FIG. 6A depicts a user computing device of a travel-based geo-paired information system operating with listener-initiated voice command with AI integration according to an embodiment;

FIG. 6B depicts a user computing device of a travel-based geo-paired information system operating with listener-initiated voice command with AI integration according to an embodiment;

FIG. 7A depicts a user computing device of a travel-based geo-paired information system operating with AI automatic initiated voice commands according to an embodiment;

FIG. 7B depicts a user computing device of a travel-based geo-paired information system operating with AI automatic initiated voice commands according to an embodiment;

FIG. 7C depicts a user computing device of a travel-based geo-paired information system operating with AI automatic initiated voice commands according to an embodiment;

FIG. 7D depicts a user computing device of a travel-based geo-paired information system operating with AI automatic initiated voice commands according to an embodiment;

FIG. 7E depicts a user computing device of a travel-based geo-paired information system operating with AI automatic initiated voice commands according to an embodiment;

FIG. 8A depicts a user computing device of a travel-based geo-paired information system with an AI generated game as the geo-paired information or content according to an embodiment;

FIG. 8B depicts a user computing device of a travel-based geo-paired information system with an AI generated game as the geo-paired information or content according to an embodiment;

FIG. 9A depicts a user computing device of a travel-based geo-paired information system integrated with a road trip application according to an embodiment; and

FIG. 9B depicts a user computing device of a travel-based geo-paired information system integrated with a road trip application according to an embodiment.

### DETAILED DESCRIPTION OF EMBODIMENTS OF THE INVENTION

As discussed above, embodiments of the present invention relate to a travel-based geo-paired information system wherein geo-paired information or content corresponds to a geolocation of the traveler and the user computing device used by and located with the traveler.

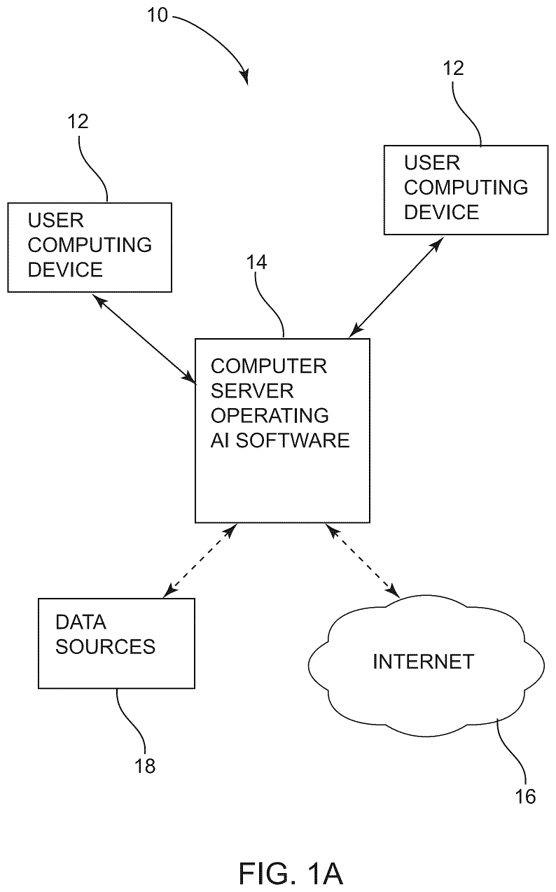

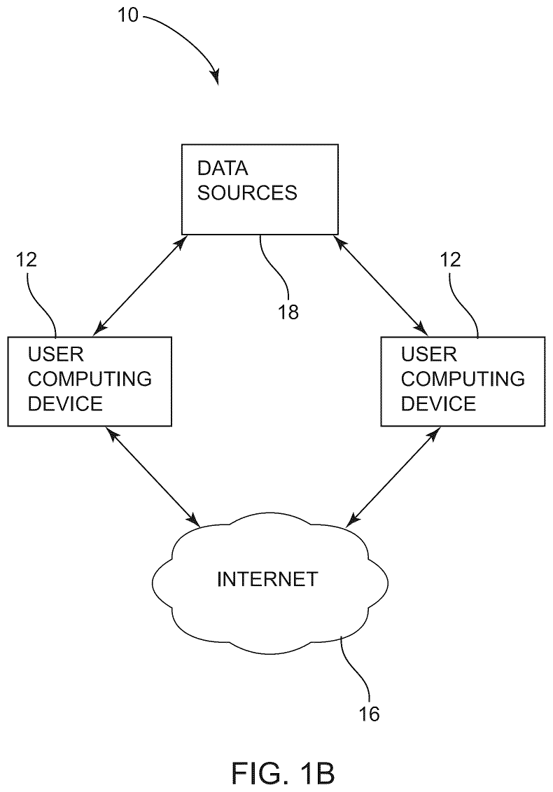

An embodiment includes a system 10 as depicted in FIGS. 1A and 1B. The system 10 may include user computing devices 12 and a server 14, wherein each user computing device 12 is coupled to the computer server 14. This coupling may be a network connection, such as through an Internet connection, a Wi-Fi connection, a Bluetooth connection or the like, wherein the user computing devices 12 may communicate with and receive communication from the server 14. The user computing device 12 may include a desktop computer, a laptop, a tablet, a smartphone, a vehicle-installed computing device and the like. The server 14, in some embodiments, may be a cloud-based infrastructure architecture. The system 10 may also include the server 14 coupled to, or having access to, the Internet 16 and/or other data sources 18, wherein the server 14, operating AI software, may access content located on the Internet 16 and other data sources 18 as part of the operation of the system 10. In other embodiments, as shown in FIG. 1B, the user computing devices 12 may be coupled directly to the Internet 16 and/or other data sources 18 and the operations of the system 10 described as programming on the server 14, may be stored and operated on the user computing device 12.

The server 14 may include a memory storing various data. The memory of the server 14 may store geo-paired information corresponding to particular points of interest geolocations, wherein location information for the points of interest geolocations is also stored and associated with the geo-paired information corresponding to the geolocations. This may be geo-paired information about the point of interest geolocation, such as historical geo-paired information relating to a point of interest geolocation, a historical account of an event occurring at a point of interest geolocation, information about the creation of a structure at a point of interest geolocation and the like. In other words, the geo-paired information may be about the geology, history, news, topics of interest, or any other information regarding the point of interest of that is within a predetermined distance of the location of the user computing device 12. Further, in some embodiments, the geo-paired information for presentation on the user computing device 12 may be generated and/or customized, utilizing artificial intelligence (“AI”) software.

The user computing device 12 may be coupled to the server 14, and, in general, the server 14 may be programmed with AI software to receive location information from the user computing device 12; automatically process the location information and determine whether a location of the user computing device 12 is within a predetermined distance from a point of interest geolocation; automatically find and retrieve geo-paired information corresponding to the point of interest geolocation; and automatically deliver to the user computing device for presenting the geo-paired information corresponding to the location of the user computing device 12. In some embodiments, the user computing device 12 may be utilized by a traveler within a vehicle (not shown). The user computing device 12 may be operating a mobile app as part of the system 10, wherein operation of the mobile app couples the user computing device 12 to the server 14. The user computing device 12 operating the mobile app, may further be operated to determine its location and send the location data to the server through the established connection. This location data, for example, may be location data obtainable by a smartphone and then sent to the server 14.

The user computing device 12 may be within vehicle and the location may be sent to the server 14. The location may be within a predetermined distance of the point of interest geolocation, thereby initiating the sending of geo-paired information corresponding to the geolocation to the user computing device 12 within the vehicle. The vehicle may include any type of vehicle, such as a car, a train, a bus, a plane, a ship, or any other type of vehicle that may not be depicted.

The system 10 may operate to provide geo-paired content, which is content from the Internet and/or other data sources corresponding to the geo-location of the user computing device 12. For example, and without limitation, the geo-paired content sent by the server 14 for presentation on the user computing device 12 may be various Internet based information based on the location of the user computing device 12. The user may set a radius or location range that sets the boundary around the user computing device 12 that the system 10 will search for corresponding geo-paired information/content, such as 5 miles, 10 miles, 25 miles, 50 miles and the like. The server 14 may be programmed to receive the location of the user computing device 12 and then, using AI software, search the Internet 16 for information corresponding to the location of the user computing device 12. The Internet 16 may include sources, such as Wikipedia, news sources, historical sources and other sources that create and store content, archive information and content, aggregate information and the like. In embodiments, the server 14 may utilize AI software to generate content gathered from the various sources that corresponds to the user preferences stored in the user's profile or account. In other embodiments, the server 14 may then send for display on the user computing device 12 one or more selectable geo-paired information/content associated with or corresponding to the location of the user computing device 12. The selectable geo-paired information/content provided by the server 14 may be determined by AI software operating on the server 14 and may be aggregated by the server 14 from various sources and the content wholly created by the AI software based on the content from the various sources. The user may then select a particular selectable geo-paired information/content, which may then display subcategories for further user selection or begin to play the geo-paired information/content. In embodiments with subcategories, the user may then select a subcategory, and the user computing device 12 will be directed to or the server 14 will send for presentation on user computing device 12, the AI generated content from the Internet information source discovered by the server 14 when the server searched the Internet 16.

It will be understood that the content accessible to the system 10 can be very broad. Rather than producing and storing its own content, the system 10, using AI software, may access all content available on the Internet 16 and/or other data sources 18 and provide it for consumption by the user computing device 12 as it corresponds to the location of the user computing device. This opens the system 10 to the ability to obtain information from a number of sources accessible from the Internet 16, such as, but not limited to, social media sources like Facebook, Instagram, TikTok or other social media platforms or feeds that correspond to the location of the user computing device 12, being part of a history club on Facebook or the like where the system 10 would push certain information to the user computing device based on geo-location of the user computing device 12, play online short videos from sources like YouTube, and so forth. Other data sources 18 may include data that is not specifically stored on websites but may be stored on other servers that are accessible through a network connection, and the like. Other data sources 18 may also include content including, but not limited to, movies, TV series, radio series, podcasts, and other multimedia content. Further, the system may include various additional functionality, such as, without limitation, a game or awards system where a user can gather points for visiting many locations, creating for posts a user's history trail with sites visited or downloaded by geo-location of the user computing device, an interface to make friends with people that have visited several of the same locations, and so forth.

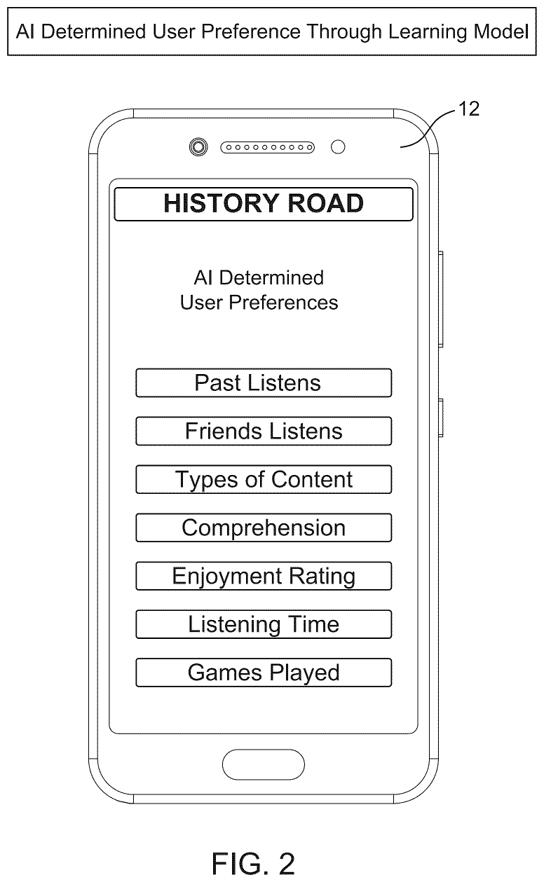

The server 14 may operate AI software in order to curate content generated by the AI software, such as generative AI. This AI software operating on the server 14 may operate to determine user preferences based on a user's interaction with the system 10 through the user computing device 12. For example, and without limitation, FIG. 2 depicts an embodiment of AI determined user preferences that include various preferences categories. It will be understood that the preference categories shown in FIG. 2 are examples and not a limitation on preference categories that may exist. As shown in FIG. 2, the AI determined user preferences may include past listens, friends' listens, types of content, comprehension, enjoyment rating, listening time, games played and the like. The AI software operating on the server 14 may utilize a learning model algorithm that can recognize patterns in the user's interaction with the system and make a prediction of what the user will like in his or her use of the system 10. For example, the learning model may analyze past listens of the user and determine what type of content he or she would like; may analyze past listens of friends, may analyze the user's comprehension based on the type of content played, may analyze the ratings that user may apply to content presented on the user computing device 12 (this may be a star rating or other rating system commonly used for rating content), may analyze listening time; may analyze games played through the system 10, and so forth. The more data the AI software has to analyze in its learning model, the more accurate the predictions will be. Therefore, as the user continues to interact with the system, the AI software's predictions will become more accurate. Additionally, if the user's interests shift, the learning model will predict whether it is an anomaly or if there is a shift in preference by the user and will adjust its predictions without the need for human interaction.

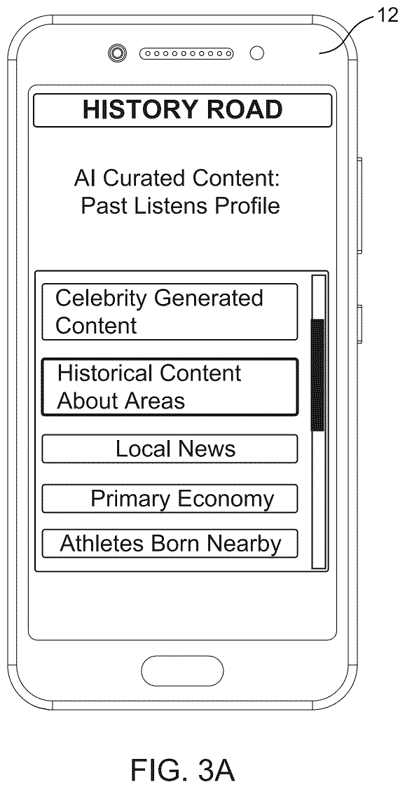

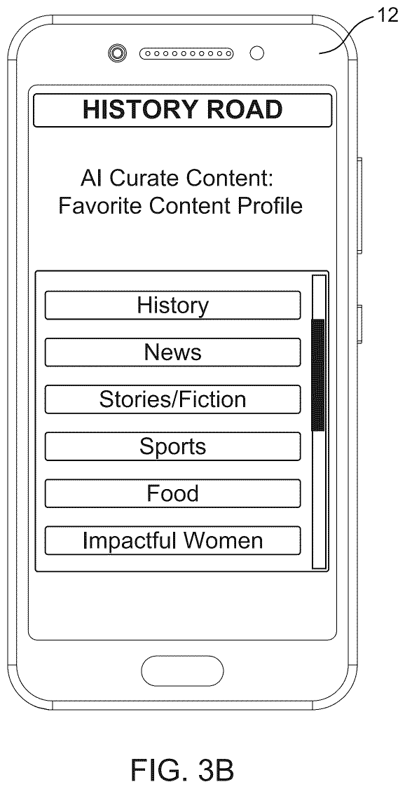

The server 14 may operate AI software in order to curate content generated by the AI software, such as generative AI. This AI software operating on the server 14 may utilize user preferences and location of the user computing device 12 generate geo-paired information/content for sending to the user computing device to be played or presented. For example, and without limitation, FIGS. 3A-3B depict an embodiment of AI curated content. The server 14 may utilize past listens stored in the user account and the current location of the user computing device 12 to locate geo-paired information/content stored in the server 14 or create by the AI software from one or more Internet sources 16 and/or other data sources 18 and send for display selectable elements for one or more playable content items for selection and playing on the user computing device 12, as shown in FIG. 3A. In FIG. 3A, the AI software executed on the server 14 may then send for selection playable content items based on the user preferences determined by the AI software, such as, for example, celebrity generated content, historical content about areas, local news, primary economy, and athletes born nearby. These content topics are just examples, and it is understood that the topics actually selected by the AI software is directly related to analysis of the user's past listens and content.

The server 14 may also operate AI software to determine favorite types of content, such as, without limitation, history, news, stories/fiction, sports, food, impactful women, and other types of content based on the user preferences, the past locations of the user computing device 12, past geo-paired information/content listened to by the user, as shown in FIG. 3B. Then the server 14 may find geo-paired information/content stored on the server 14 corresponding to the location of the user computing device 12 or create by the AI software from one or more Internet sources 16 and/or other data sources 18 and send for display selectable elements for one or more content topics for selection and playing on the user computing device 12, as shown in FIG. 3B.

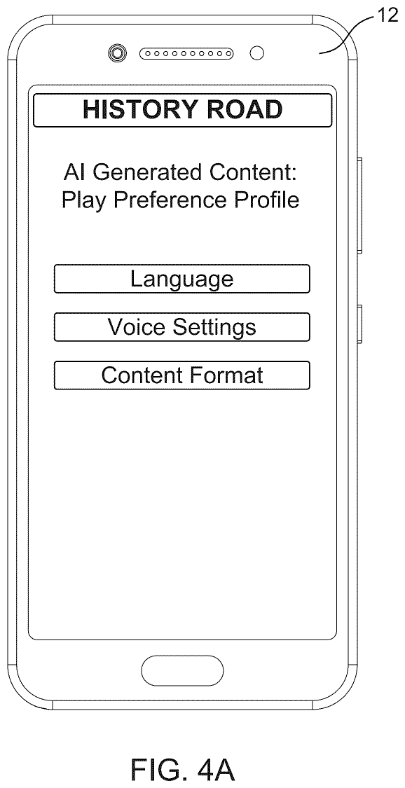

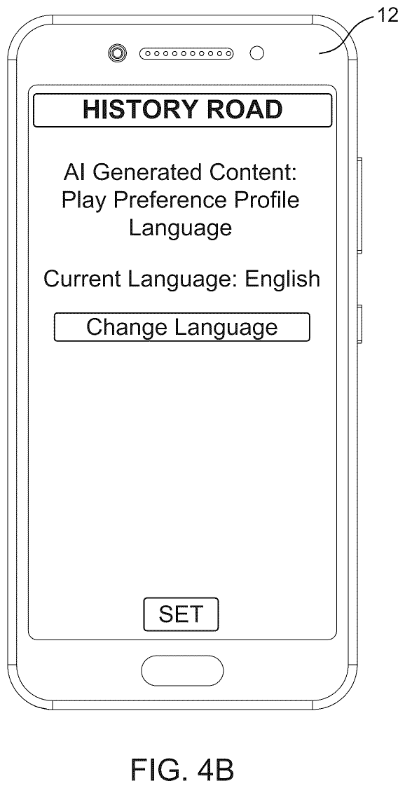

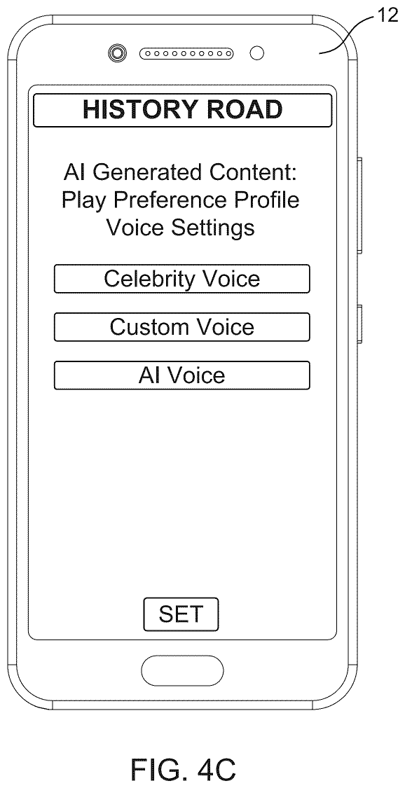

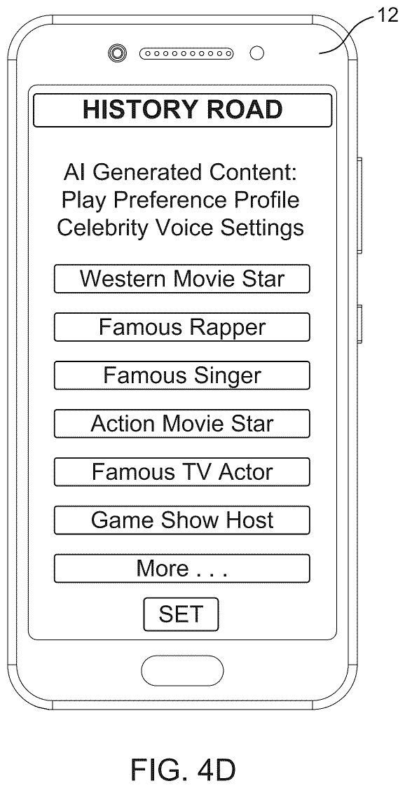

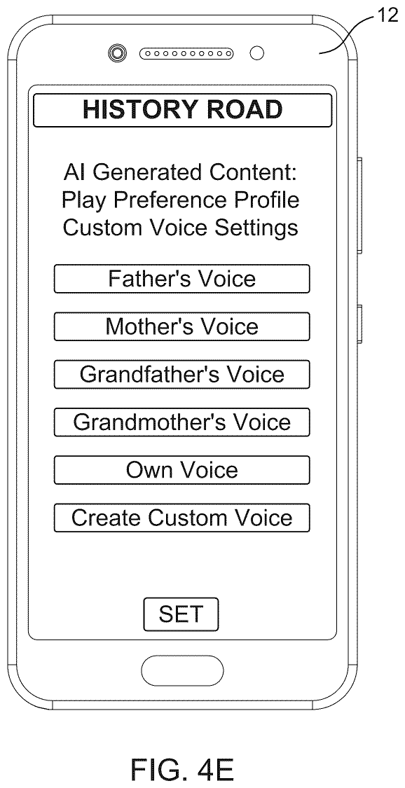

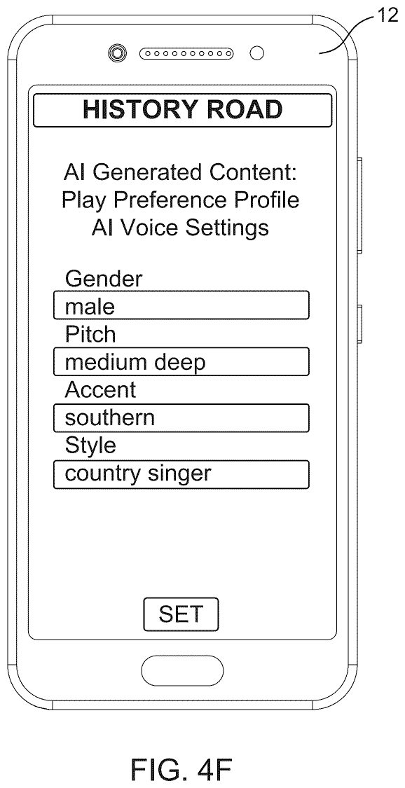

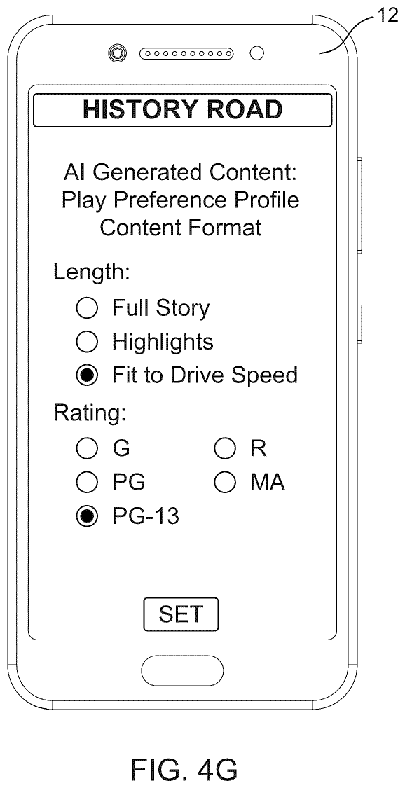

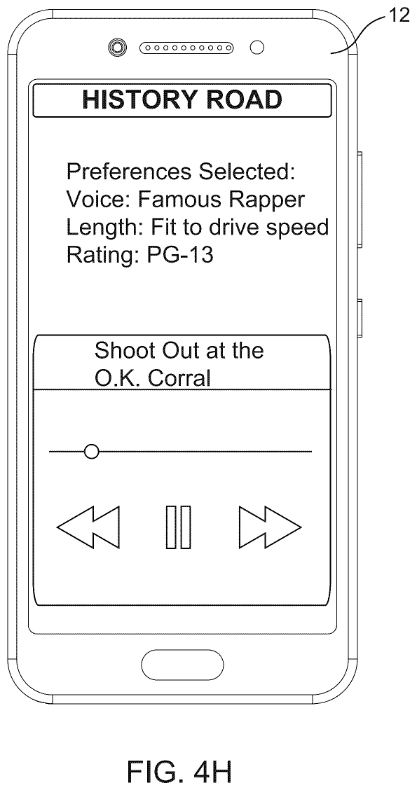

Further, the AI software operating on the server 12 may operate to create an AI generated content play preference profile as depicted in FIGS. 4A-4H. As depicted in FIG. 4A, AI software may determine, from historical information related to the user's utilization of the system 10 that has been stored on the user account, a plurality of play preferences. For example, and without limitation, the play preference profile may include language, voice settings, content format and so forth, as shown in FIG. 4A.

The language preference, if selected from the interface of FIG. 4A, may result in the server 14 sending for display on the user computing device 12 a user interface with a currently set language and a selectable element that allows for a user to change the current language relating to a language for content to be played, as shown in FIG. 4B. The user may select one of the languages and set his play preferences to that language. AI software may then operate to generate content in the selected language.

The voice setting preference, if selected from the interface of FIG. 4A, may result in the server 14 sending for display on the user computing device 12 a user interface with a selectable elements that allows for a user to change the voice settings relating to content to be created and played, as shown in FIG. 4C. These voice setting may include celebrity voice, custom voice, AI voice and so forth.

Referring to FIGS. 4C and 4D, a celebrity voice preference, if selected from the interface of FIG. 4C, may result in the server 14 sending for display on the user computing device 12 a user interface with a plurality of selectable elements relating to a celebrity voice for content to be played, as shown in FIG. 4D. For example, and without limitation, the celebrity voice selectable elements, may include western movie star, famous rapper, famous singer, action movie star, famous TV actor, game show host and any other celebrity. The user may select one of the celebrities and set his play preferences to that celebrity. It will be understood that permission may be required for use of a celebrity voice. Additionally, it will be understood that the AI software may then operate to generate the audibly read content in the celebrity's voice by utilizing past audio of the celebrity as a learning model that can then be applied to the content to be presented on the user computing device 12 to present the AI generate celebrity voice presenting the content.

Referring to FIGS. 4C and 4E, a custom voice preference, if selected from the interface of FIG. 4C, may result in the server 14 sending for display on the user computing device 12 a user interface with a plurality of selectable elements relating to a custom voice for content to be played, as shown in FIG. 4E. For example, and without limitation, the custom voice selectable elements of previously uploaded voice samples that may include a father's voice, a mother's voice, a grandfather's voice, a grandmother's voice, the user's own voice, and any other custom voice. The user may select one of the custom voices and set his play preferences to that custom voice, or alternatively, the user may select to create a custom voice. In selecting to create a custom voice, the user computing device 12 may upload to the server 14 a sample of the voice that the user wishes content to be read in. It will be understood that the AI software may then operate to generate the audibly read content in the custom voice by utilizing uploaded audio of the custom voice as a learning model that can then be applied to the content to be presented on the user computing device 12 to present the AI generate custom voice presenting the content.

Referring to FIGS. 4C and 4F, an AI voice settings, if selected from the interface of FIG. 4C, may result in the server 14 sending for display on the user computing device 12 a user interface with a plurality of selectable elements relating to an AI voice characteristics to be used with the AI generated and played content, as shown in FIG. 4F. For example, and without limitation, the language selectable elements, may include gender of voice, pitch of voice, accent of voice, style of voice and the like. The user may select or enter text related to each of the selectable elements. For example, and without limitation, FIG. 4F depicts selection of a male voice, with a medium deep pitch, a southern accent, and a voice style of a country singer. AI software may then operate to present content in the selected AI voice settings that are generically modeled using the elements selected.

The content format preference, if selected from the interface of FIG. 4A, may result in the server 14 sending for display on the user computing device 12 a user interface with a selectable elements that allows for a user to change the content format to be created and played, as shown in FIG. 4G. For example, the content format may include a length of time preference selectable element that allows a user to select a length of time for the content. For example, and without limitation, the length of time may be quantified in content type, such as full story, highlights, or fit to drive speed, as shown in FIG. 4G. This results in the AI generated content to either generate an entire story, just highlights, or customize the length of time story to the drive speed the user computing device 12 is travelling at. Another example of a selectable element for content format is maturity rating, such as, but not limited to rating similar to movie ratings, namely, G, PG, PG-13, R and MA. The rating selectable element may then operate to add or remove aspect of the content related to language, violence, sex and so forth similar to that associated with movie ratings. The AI software may then generate content based on the content format settings that use selects through the user interface depicted in FIG. 4G.

FIG. 4H depicts an example of the AI generated content playing on the user computing device 12 using the play preference profile selected by the user. For example, and without limitation, the content related to the “Shoot Out at the O.K. Corral” may be played on the user computing device 12 that have preferences selected of a celebrity voice of a famous rapper, for a length of fit to the drive speed and rating of PG-13. It is understood that this content was generated by AI, including the length, rating, and the celebrity voice being mimicked due to operation of the AI software.

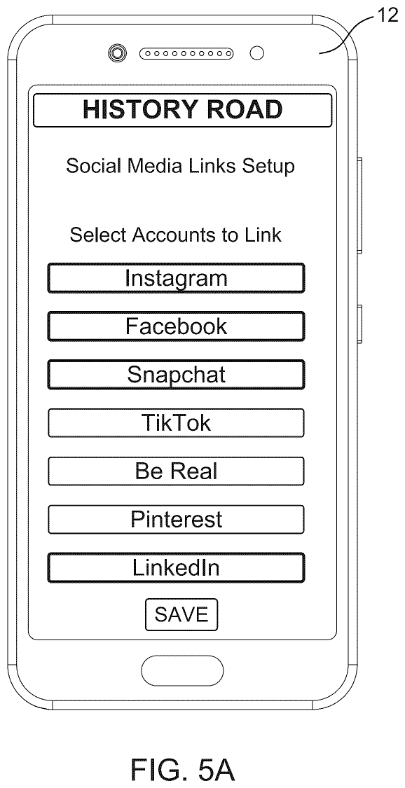

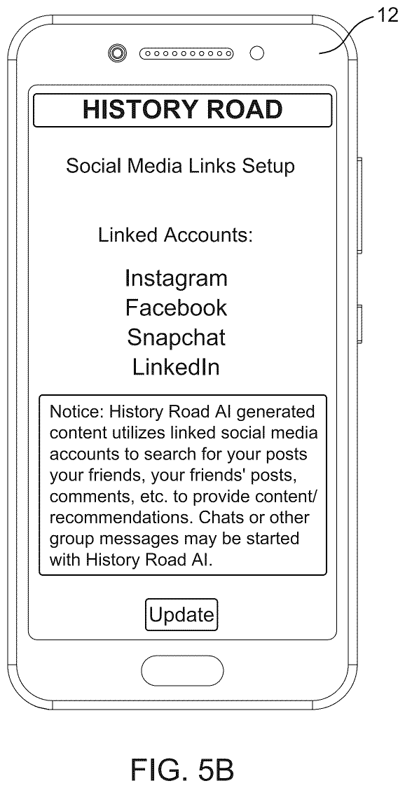

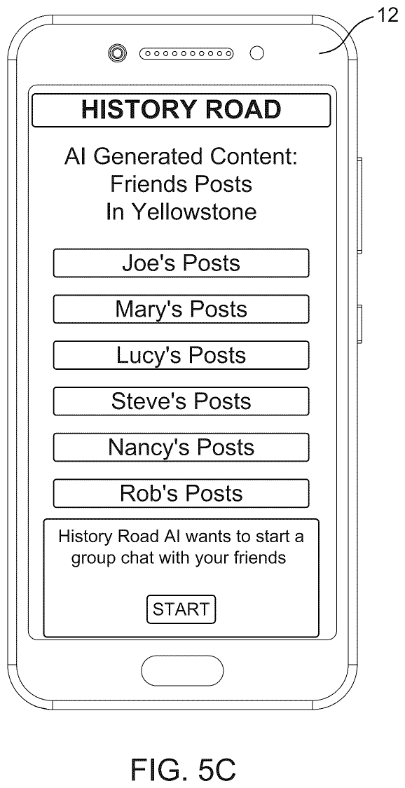

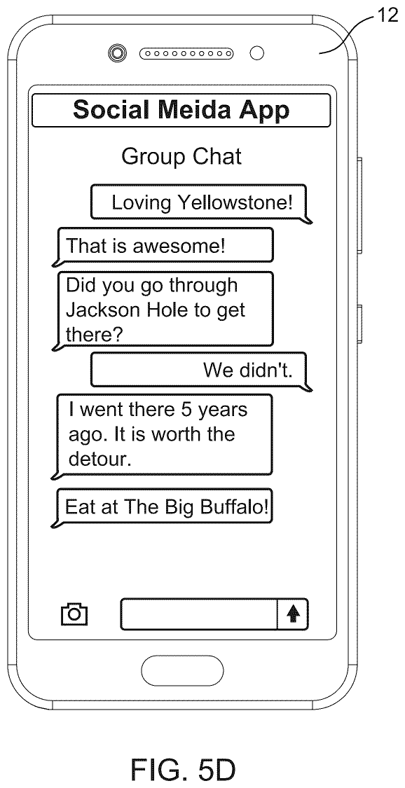

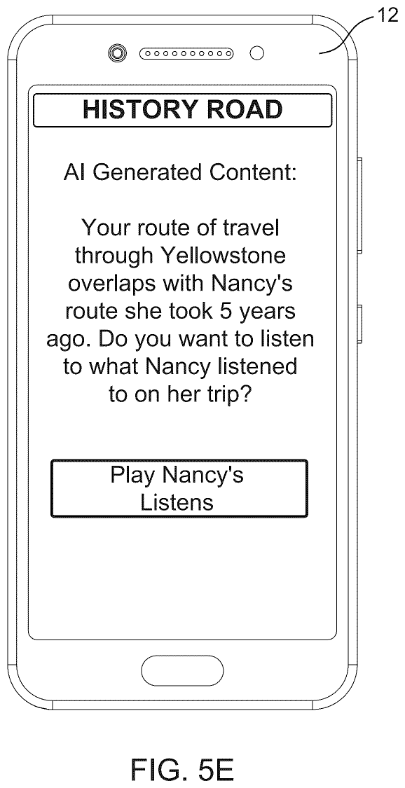

Referring to FIGS. 5A-5E, the AI integrated system 10 may include a social aspect for users. The server 14 may be programmed with AI software that can link the system 10 to social media accounts of the user. For example, the server 14 may send for display on the user computing device 12, a friend links setup, wherein the user interface has a plurality of selectable social media elements corresponding to various social media platforms, as shown in FIG. 5A. For example, and without limitation, the selectable social media elements may include Instagram, Facebook, Snapchat, TikTok, Be Real, Pinterest, LinkedIn and so forth. The user may select one or more of the selectable social media elements. Saving the selections results in the AI software linking the system 10 to the social media accounts, as shown in FIG. 5B. The AI software may access the posts of the user and the user's friends and determine the social friends that the server 14 accesses may be through the linking of the other social media systems to the system 10. In these embodiments, the server 14, operating AI software, may determine what friends have posted on their social media accounts and the like when they were in the same geo-location as the user computing device 12, and the server 14 may then send the content of the posts to the user computing device 12 for playing, such as in the form of selectable elements that when selected will initiate presentation or playing of the content of the social media posts, as depicted in FIG. 5C. In embodiments, the system 10 may utilize a communication from the user computing device 12 to start a group chat with friends, such as a group chat with the friends that have travelled by the same point of interest or the like. This allows the friends to communicate via the group chat, as shown in FIG. 5D. It will be understood that this group chat may occur in the system 10 through a user interface, or the system 10 may start a group chat in a desired social media platform to which the system 10 is linked. Further still, the AI software operating on the server 14 may determine that a friend from a social media platform has travelled the same route the user is travelling and send content that the friend listened to while travelling the same route, as depicted in FIG. 5E.

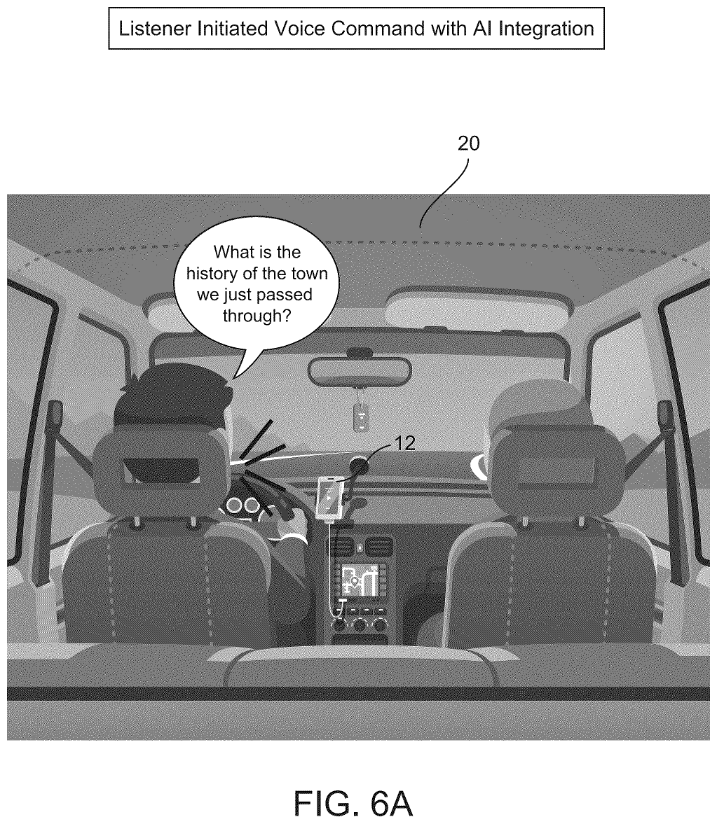

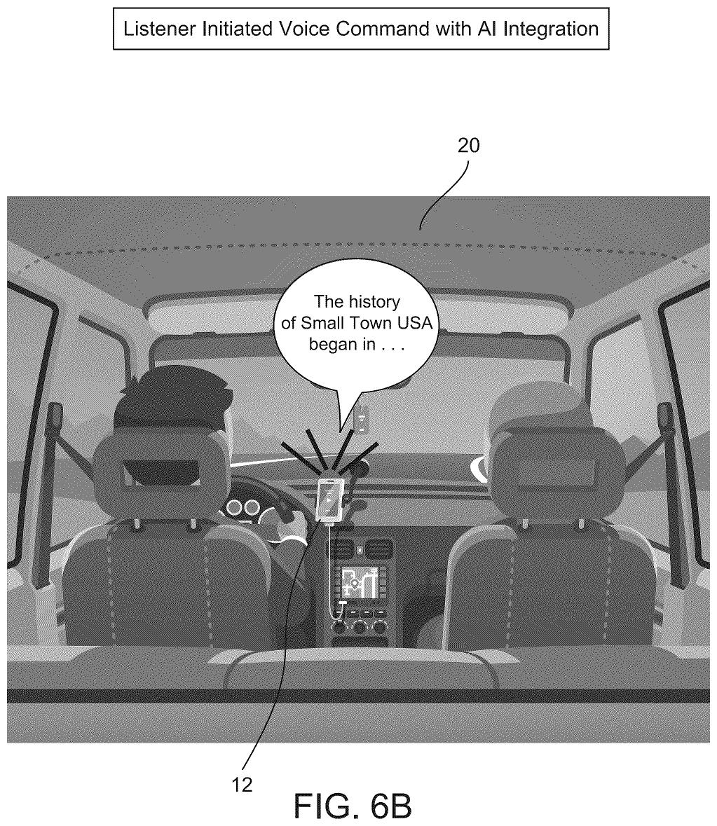

In embodiments, the travel-based geo-paired information system 10 may include a user computing device 12 operating an application that may be programmed to receive and send audible prompts, wherein the audible prompts result in the system operating as though there are tactile input. It will be understood that natural language processing may be performed by the AI software and may be included as part of the system that allows for the receipt of audible prompts and/or voice commands and processing the audible prompts and/or voice commands in order to trigger operations by the server 14, the user computing device 12 or the like. One example may include a user-initiated voice command where the system has AI integration. For example, FIGS. 6A and 6B depict a user in a vehicle that initiates an audible command to the user computing device 12, such as, “What is the history of the town we just passed?” as depicted in FIG. 6A. The user computing device 12 may then, in communication with the server 14 or from downloaded content, receive instructions or execute instruction respectively to then play the content requested, as depicted in FIG. 6B.

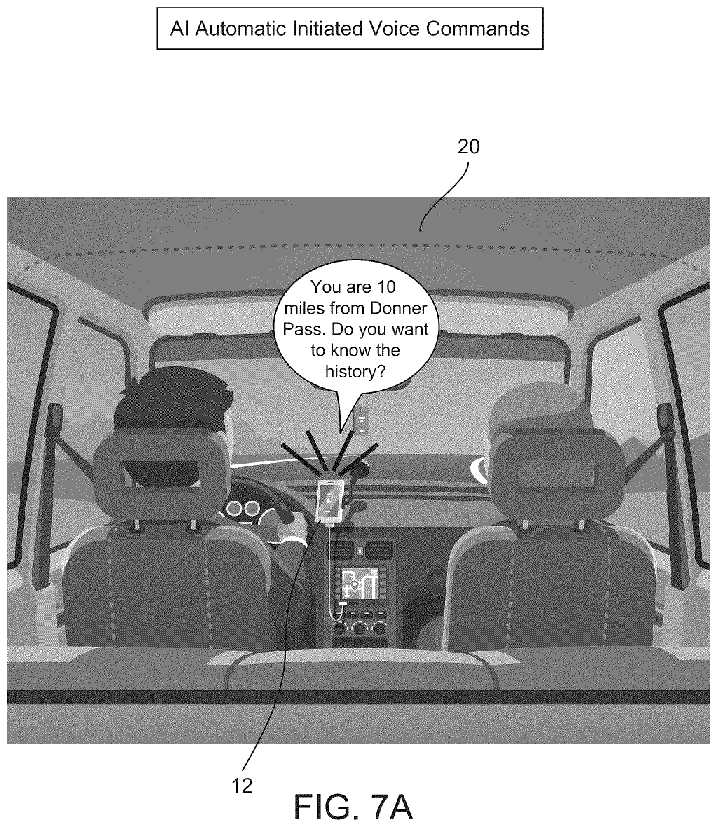

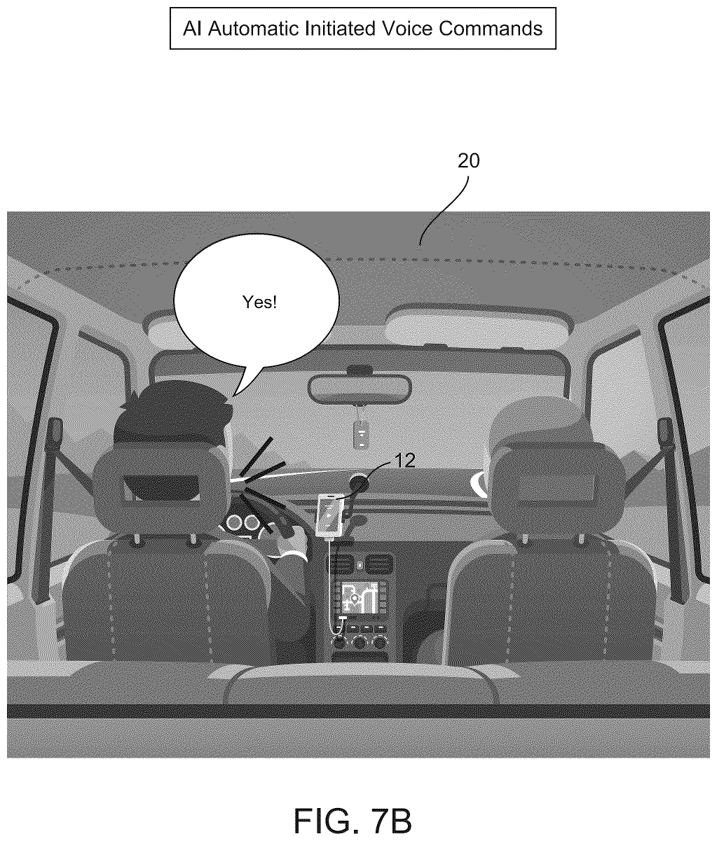

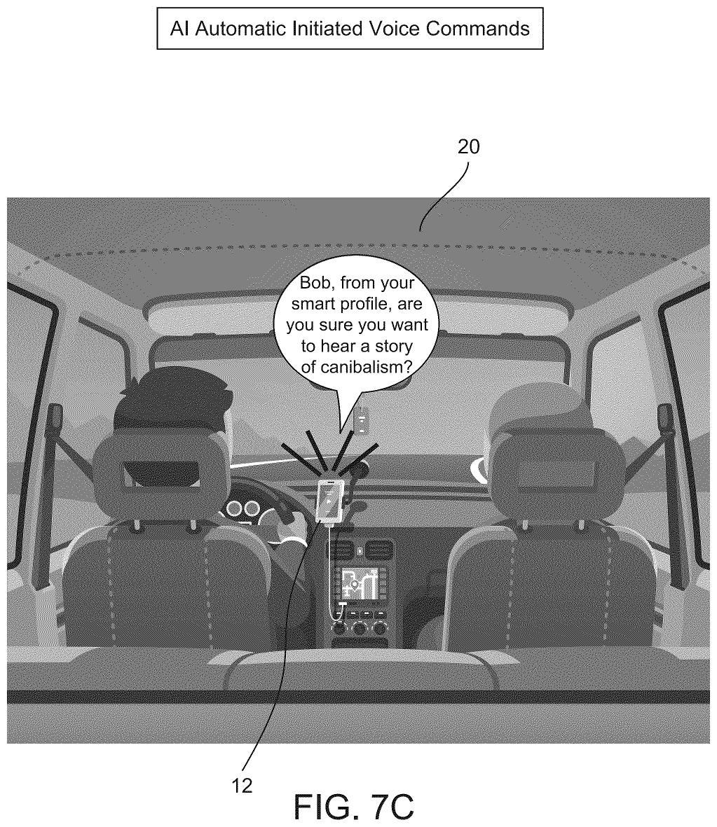

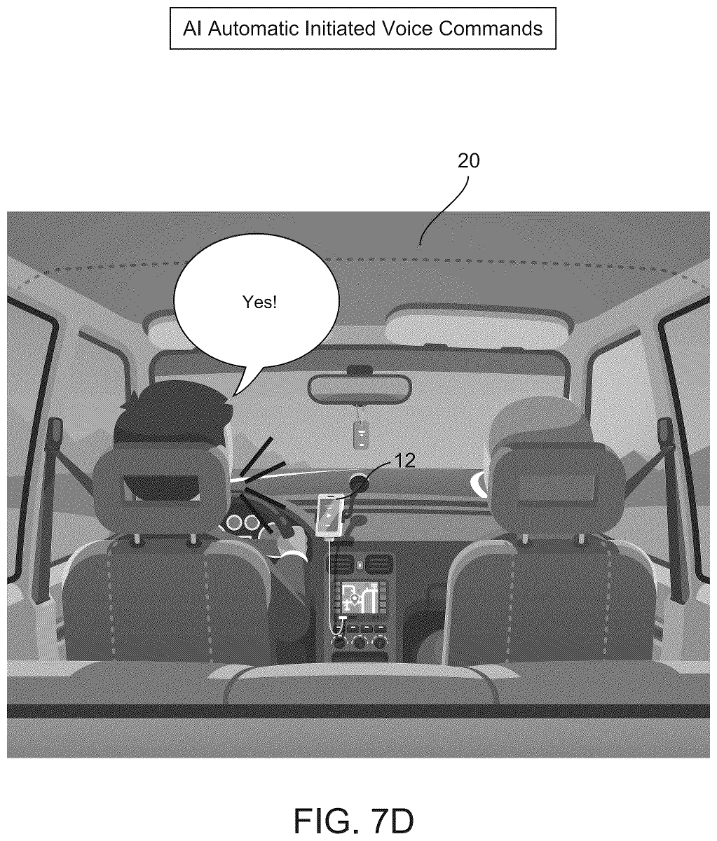

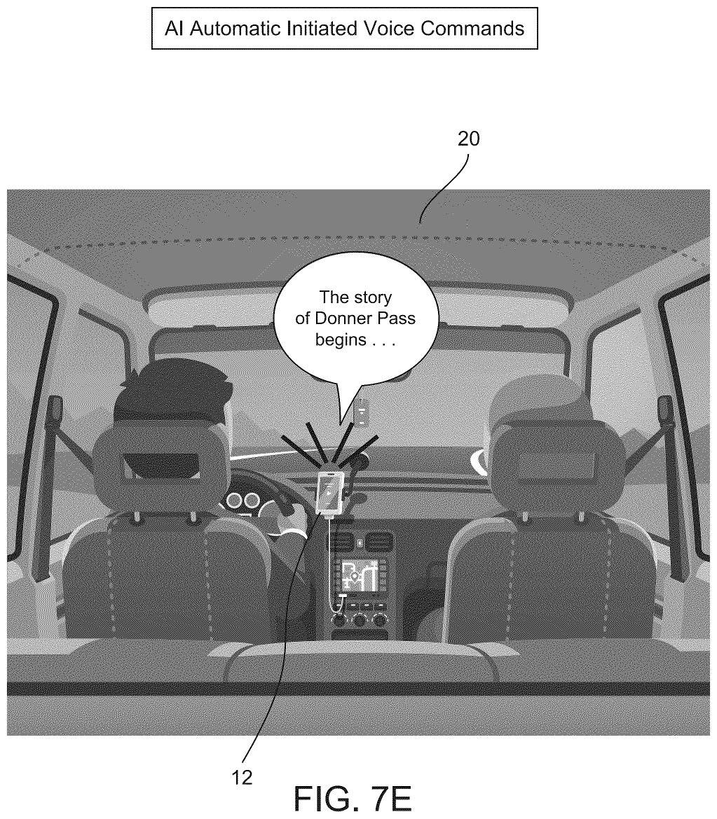

In other embodiments that utilize AI software, the AI software may automatically initiate the voice command, such as that shown in FIGS. 7A-7E. In these embodiments, the server 14 or the user computing device 12, based on the geo-location of the user computing device 12, may initiate a voice prompt. For example, and without limitation, the user computing device 12 may send geo-location to the server 14. The relevant prompt may correspond with the preferences of the user that is stored in the server 14 associated with the user account and the geo-location of the user computing device 12. The prompt may include a question eliciting a verbal response, such as, “You are 10 miles from Donner Pass. Do you want to the know the history?” as depicted in FIG. 7A. The user computing device 12 may then automatically go into a listening mode to receive a verbal audible command from the user, such as “Yes” as shown in FIG. 7B. The command may be an affirmative or negative response, like “yes” or “no,” wherein an affirmative response would result in the user computing device 12, in connection with the server 14 to play the geo-paired content on the user computing device 12 as shown in FIG. 7E. A negative audible command would result in not playing the geo-paired content. In embodiments, the server 14 may be programmed to send for playing on the user computing device 12, another audible prompt for a different type of geo-paired content from the initial audible prompt corresponding to the geo-location of the user computing device 12, which may continue until all geo-paired content has been presented in as an audible prompt. In some embodiments, the AI software operating on the server 14 may analyze the user's past listens and preferences and determine the content associated with the location of the user computing device 12 may not be content that the user likes. In this example, as shown in FIG. 7C, another audible prompt may be sent to the user computing device, such as, “Bob, from your smart profile, are you sure you want to hear a story of cannibalism?” The user computing device 12 may then automatically go into a listening mode to receive a verbal audible command from the user, such as “Yes” as shown in FIG. 7D, resulting in the playing of the geo-paired content on the user computing device 12 as shown in FIG. 7E. Further, after playing geo-paired content after an affirmative command, the system 10 may operate to continue to present additional audible prompts for other geo-paired content corresponding to the geo-location of the user computing device 12.

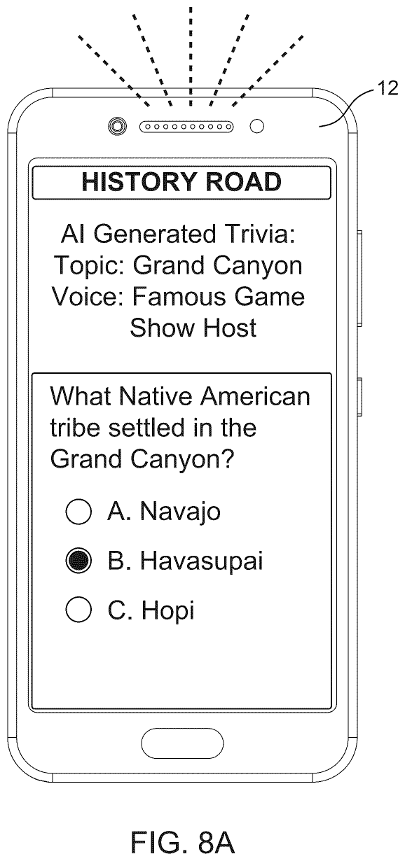

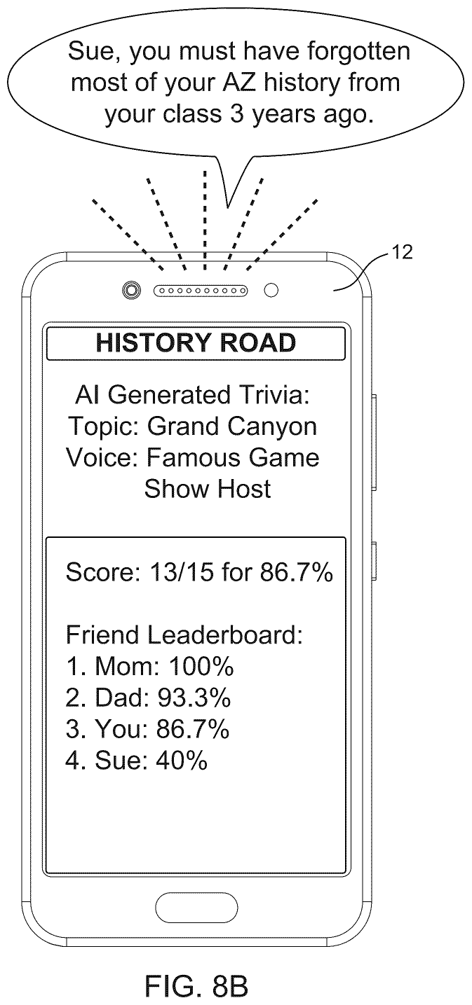

Additionally, embodiments may include AI generated geo-paired content that is a game, such as that shown in FIGS. 8A-8B. For example, the server 14, operating AI software, may send for presenting on the user computing device 12, a game type content related to the geo-location of the user computing device 12. Additionally, the server 14, using AI software to process user preferences stored in the user profile, may operate to customize the game for the user based on the user preferences. For example, and without limitation, based on the likes and preferences of the user, the game may be a trivia game as depicted in FIG. 8A with a voice of a famous game show host, or any other type of game and voice that may include information corresponding to the geo-location of the user computing device 12. The trivia game as shown in FIG. 8A, may include a series of questions, such as the question related to the Grand Canyon as depicted in FIG. 87A. Further, the game may keep track of your score and compare it to others in the vehicle or to others that have played the same game in the same general geo-location and depict your score relative to others, such as that shown in FIG. 8B. The system may also utilize AI software to interact with the user based on the user's preferences and initiate comments to the user, as depicted in IFG. 8B based on the score of the user playing the game. It will be understood that many different types of games for various types of ages may be available, such as a trivia game for adults, or an adventure game or the like for kids, etc. The AI software operated on the server 14 may determine and curate the kids games to ensure it will have age appropriate content to keep the interest of the children, teens or the like. The age of the users may be stored by the server 14 and the server 14 may be programmed with AI software to deliver the appropriate geo-paired content for presentation on the user computing device 12. It will also be understood that the system 10 may employ a natural language processing AI software that can recognize different voices, wherein multiple players may play the game using the same device and the server 14 or the user computing device 12 operating the natural language processing software may differentiate between different voices and track scores for all players using the same device. Additionally, the system 10 may be configured so that multiple vehicles may be able to play the game against each other in real time. The other vehicles may include friends, a caravan of vehicles traveling together, strangers or the like.

Additionally, the game depicted in FIGS. 8A-8B may also be a game or quiz that can be utilized for educational curriculum. The user computing devices 12 may be operated by students and the questions may be directed to history or other information that the students are participating in such as during a field trip. The questions may be used for students to answer basic questions to show that they actually participated in the tour or even to login hours to show that the student was there. Because this is location based and the location of the user computing device 12 is determined, accessing the system 10 by the student within proximity of the of the point of interest the students are supposed to be visiting can confirm their attendance at the point of interest or event that brings the students within proximity.

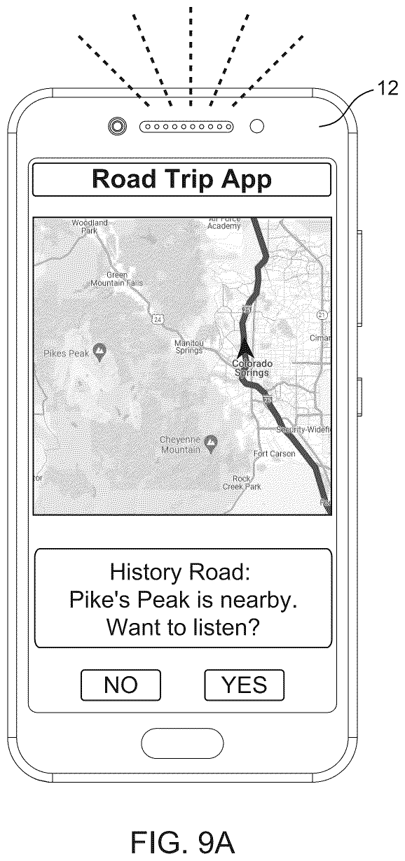

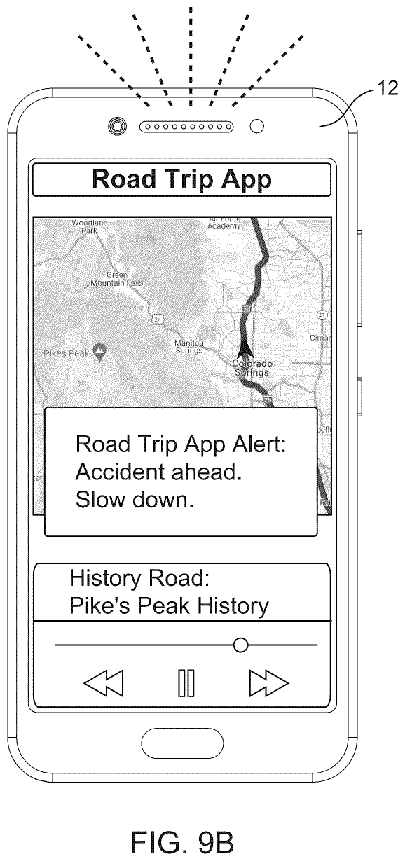

In other embodiments, the system 10 may be incorporated with a travel navigation application, as shown in FIGS. 9A-9B. In these embodiments, the system 10 may operate as described above, however, the route planned though the travel navigation application supplies additional information to the server 14 for processing and locating or creating content through AI software and provide a prompt to play the AI created content, as shown in FIG. 9A. The user interface as shown in FIG. 9B may include the navigation and the playing of content. It will be understood that the system 10 is programmed to not interfere with the native functionality of the travel navigation application. For example, and without limitation, things like alerts, notifications, real time tracking of location along the route are all operational. In instance of an alert, for example, the system will pause the playing of the content in order to provide an audible alert, such as, “Accident ahead. Slow down.” as shown in FIG. 9B. In these embodiments, the system 10 operates to enhance the interaction with the travel navigation application.

Embodiments may be available on or through the internet, such as through domain names reserved and owned by Applicant that include aihistoryroad.com, historyroadai.com, whatsaheadai.com, triptickai.com, gpsjouney.com, aionthehighway.com, aiwaypoint.com, aiwaypoint.com, aistoryteller.info, aicartrip.com, cartripai.com, aaahere.com, triptikai.com, autioai.com, aitravelor.com or the like.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A travel-based geo-paired information system with AI integration, the system comprising:
a server having a memory storing geo-paired information; and
a user computing device coupled to the server, wherein the server is programmed with AI software to:
receive location information from the user computing device;
automatically process the location information and determine whether a location of the user computing device is within a predetermined distance from a point of interest geolocation;
automatically find and retrieve geo-paired information corresponding to the point of interest geolocation;
automatically deliver to the user computing device for presenting content corresponding with the geo-paired information corresponding to the location of the user computing device; and
execute a learning model to determine user preferences based on predictions formed through execution of the learning model on past interactions with the system through the user computing device.

2. The system of claim 1, wherein the server is programmed to execute the learning model to determine play preferences.

3. The system of claim 2, wherein the play preference profile comprises one or more of language of the content, voice settings, and content format.

4. The system of claim 3, wherein the server programmed to automatically deliver to the user computing device for presenting the content corresponding with the geo-paired information corresponding to the location of the user computing device comprises creating the content based on the play preference profile.

5. The system of claim 4, wherein the server programmed to create the content based on paly preference profile comprises generating audio of the content using AI software to mimic a celebrity voice, to mimic a custom voice, or to use a generically AI created voice.

6. The system of claim 2, wherein the server is further programmed with AI software to generate content from a plurality of sources on the Internet and a plurality of other data sources.

7. The system of claim 1, wherein the server is further programmed to communicate with the user computing device through voice commands.

8. The system of claim 1, wherein multiple types of geo-paired information is associated with a point of interest geolocation.

9. A travel-based geo-paired information system with AI integration, the system comprising:
a server having a memory storing geo-paired information; and
a user computing device coupled to the server, wherein the server is programmed with AI software to:
receive location information from the user computing device;
automatically process the location information and determine whether a location of the user computing device is within a predetermined distance from a point of interest geolocation;
automatically find and retrieve geo-paired information corresponding to the point of interest geolocation;
automatically deliver to the user computing device for presenting content corresponding with the geo-paired information corresponding to the location of the user computing device; and
link one or more social media platforms with the system, the one or more social media platforms corresponding to social media accounts of the user.

10. The system of claim 9, wherein the server is programmed to execute a learning model to determine friends based on friends of the user on the one or more social media platforms that also use the system.

11. The system of claim 10, wherein server is programmed to locate posts on social media platforms by friends and send the posts as content to be played on the user computing device.

12. The system of claim 11, wherein the server is programmed to create a group chat with the friends.
